(19) United States
(12) Patent Application Publication
(10) Pub. No.: US 2010/0123058 A1
(43) Pub. Date: May 20, 2010

(54) PORTABLE OUTDOOR MOTOR CONTROL FOR MULTI-STATION ENCLOSED CABIN BOATS

(76) Inventor: Stanley Benjamin Palmer, Silverdale, WA (US)

Correspondence Address: Stanley B. Palmer, 6665 NW Newberry Hill Rd, Silverdale, WA, 98383, US

(21) Appl. No.: 12/621,409

(22) Filed: Nov. 18, 2009

Related U.S. Application Data
(60) Provisional application No. 61/116,070, filed on Nov. 19, 2008.

(51) Int. Cl. F16M 13/00

(52) U.S. Cl. 248/201

(57) ABSTRACT

A system for mounting a motor control unit at a position on a boat comprises: a mounting bracket mountable to the position on the boat; a sliding bracket attachable to the motor control unit and operable to slide into the mounting bracket; and a quick-release mechanism operable to secure the sliding bracket to the mounting bracket.

### RELATED APPLICATIONS

The present application claims benefit of priority from U.S. Provisional Application No. 61/116,070, filed Nov. 19, 2008, which is incorporated herein by reference in its entirety.

### BACKGROUND OF THE INVENTION

The present invention generally relates to a portable outdoor motor control system for multi-station enclosed cabin boats. On some boats, there may be a need to control the boat speed and direction from both within a cabin and outside of the cabin on the boat through the use of a motor control unit.

As can be seen, there is a need to quickly and easily move a motor control unit from station to station on a boat in order to provide the same function at all of the stations of a boat.

### SUMMARY OF THE INVENTION

In one aspect of the present invention, a system for mounting a motor control unit at a position on a boat comprises: a mounting bracket mountable to the position on the boat; a sliding bracket attachable to the motor control unit and operable to slide into the mounting bracket; and a quick-release mechanism operable to secure the sliding bracket to the mounting bracket.

In another aspect of the present invention, a system for mounting a motor control unit at multiple positions on a boat comprises: a first mounting bracket operable to mount the motor control unit at a first position on the boat; a second mounting bracket operable to mount the motor control unit at a second position on the boat; a sliding bracket attachable to the motor control unit and operable to slide into the first mounting bracket and the second mounting bracket; and a quick-release mechanism operable to secure the sliding bracket to the first mounting bracket to secure the motor control unit to the first mounting bracket and also operable to secure the mounting bracket to the second mounting bracket to secure the motor control unit to the second mounting bracket.

In another aspect of the present invention, a method for moving a motor control unit from a first station on a boat to a second station on the boat comprises: removing a quick-release mechanism that secures the motor control unit to a first mounting bracket operable to mount the motor control unit at the first station; and attaching the quick-release mechanism to the second mounting bracket to secure the motor control unit to the second mounting bracket.

These and other features, aspects and advantages of the present invention will become better understood with reference to the following drawings, description and claims.

### BRIEF DESCRIPTION OF THE DRAWINGS

FIG. 1 shows a schematic partial section view of a boat in accordance with an embodiment of the present invention;

FIG. 2 shows a perspective view of a portable outboard motor control system showing how a sliding bracket attached to a motor control unit may slide into a mounting bracket and may be secured by a quick release mechanism or pin in accordance with an embodiment of the present invention;

FIG. 3 shows a schematic partial section view of a boat shown with a motor control mounted in a second outside position in accordance with an embodiment of the present invention; and

FIG. 4 shows a partial rear view of a boat having a motor control mounted in a second outside position in accordance with an embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provides a portable outdoor motor control system for multi-station enclosed cabin boats so that a single motor control unit may be moved to and used at multiple stations both inside and outside a cabin of a boat.

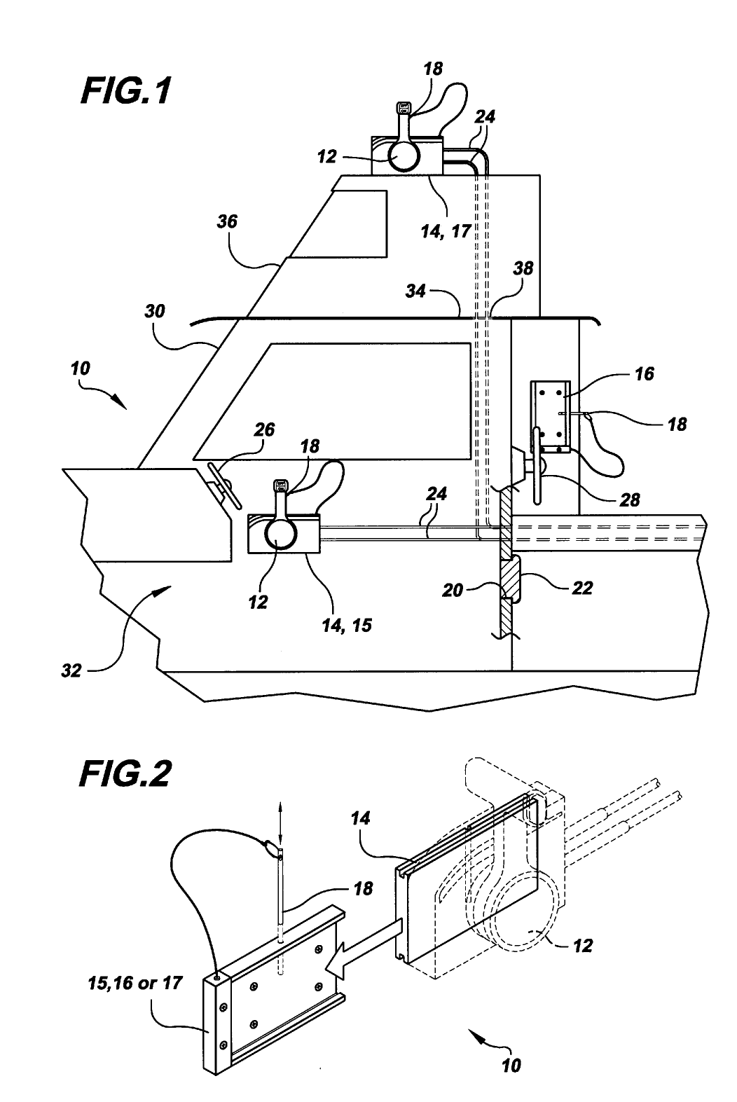

FIG. 1 shows a schematic partial section view of a boat in accordance with an embodiment of the present invention. As shown in FIG. 1, a portable outboard motor control system 10 may allow a motor control unit 12 to be mounted at multiple stations within the boat 32, such as near a wheel or helm station in a first inside position 26 inside a cabin 30 of the boat 32, a wheel or helm station in a second outside position 28 outside of the cabin 30 of the boat 32, or at a position on a bridge 36 on top of a roof 34 of the cabin 30 of the boat 32.

The motor control unit 12 may be mounted to a position on the boat 32 via a sliding bracket 14, a motor control mounting bracket 15, 16, or 17, and quick release mechanism or pin 18. Cables 24 may run from the motor of the boat 32 to the motor control unit 12 via rear wall opening 20 when the motor control unit 12 is positioned near the wheel or helm station in the second outside position 28 out side of the cabin 30 of the boat 32, or via roof opening 38 when the motor control unit 12 is positioned on top of the bridge 36. A cap 20 may be used to cover the rear wall opening 20 when not in use to route the cables 24.

FIG. 2 shows a perspective view of a portable outboard motor control system showing how a sliding bracket attached to a motor control unit may slide into a mounting bracket and may be secured by a quick release mechanism or pin in accordance with an embodiment of the present invention. As shown in FIG. 2, a portable outboard motor control system 10 may comprise a sliding bracket 14, a motor control mounting bracket 15, 16, or 17, and a quick release mechanism or pin 18. The sliding bracket 14 may be attachable to a motor control unit 12, and may comprise grooves along the top and bottom in order to slide into the motor control mounting bracket 15, 16, and 17. The motor control mounting bracket 15, 16, or 17 may be mounted to a desired position for the motor control unit 12 on the boat 32 and may comprise corresponding rails that allow the sliding bracket 14 to slide and fit with the motor control mounting bracket 15, 16, and 17. The sliding bracket 14 may be slid into the motor control mounting bracket 15, 16, or 17 and the sliding bracket 14 may be secured to the motor control mounting bracket 15, 16, or 17 via the quick release mechanism or pin 18 that slides through holes on the motor control mounting bracket 15, 16, or 17 and on the sliding bracket 14, thus securing the motor control unit 12 to a position on the boat 32.

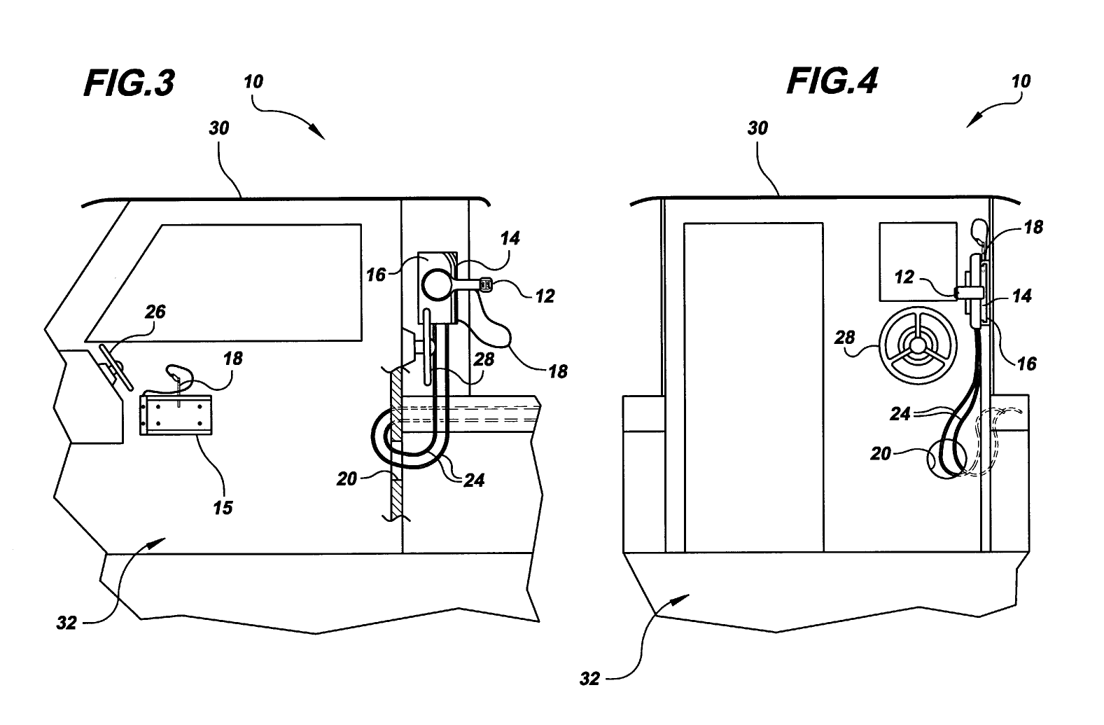

FIGS. 3 and 4 show views of the motor control unit 12 mounted at a second outside position of the boat 32 in accordance with embodiments of the present invention. As shown in FIGS. 3 and 4, the motor control unit 12 may be mounted near the wheel or helm station in the second outside position 28 via a sliding bracket 14, a motor control mounting bracket 16, and a quick release mechanism or pin 18, with cables 24 routed from the boat motor through rear wall opening 20 of the cabin 30. As can be seen, because the motor control unit 12 is mounted at the second outside position, the motor control mounting bracket 15 inside of the cabin 30 near the wheel or helm station in the first position 26 may be empty and not attached to a motor control unit 12.

The motor control unit 12 may be a unit manufactured by YAMAHA™, EVINRUDE™, HONDA™, or any other manufacturer. The first motor control mounting bracket 14 and the second motor control mounting bracket 16 may be manufactured to match the attachment points of the motor control unit 12. The quick release mechanism or pin 18 may be operable to attach the motor control unit 12 to the first motor control mounting bracket 15 and the second motor control mounting bracket 16.

The first motor control mounting bracket 15 may be operable to receive the motor control unit 12 mounted to the sliding bracket 14 and may be mounted on a first inside position inside the cabin 30 at a standard motor control location. The second motor control mounting bracket 16 may be configured identically to the first motor control mounting bracket 15, may also be operable to receive the motor control unit 12 mounted to the sliding bracket 14, and may further be mounted on a second outside position outside of the cabin 30 close to the outside wheel or helm station 28 in the second outside position. The third motor control mounting bracket 17 may be configured identically to the first control mounting bracket 15 and second control mounting bracket 16, and may further be mounted on a position on top of a bridge 36 on the boat 32.

In use, the motor control unit 12 may be moved from first inside position of the cabin 30 to the second outside position without disassembly. The motor control unit 12 may be released from the first motor control mounting bracket 15 via the quick release mechanism or pin 18 and sliding the sliding bracket 14 from the first motor control mounting bracket 15, and then routed along with its attached cables 24 from the first inside position through the opening 20 in the rear wall of the cabin 30 to the second outside position. Once the motor control unit 12 is at the desired location, the motor control unit 12 may be mounted to the second motor control mounting bracket 16 via the quick release mechanism or pins 18 by sliding the sliding bracket 14 into the second motor control mounting bracket 16 and securing the sliding bracket 14 to the second motor control mounting bracket 16 via the quick release mechanism or pin 18 at the second motor control mounting bracket.

It should be understood, of course, that the foregoing relates to exemplary embodiments of the invention and that modifications may be made without departing from the spirit and scope of the invention as set forth in the following claims.

We claim:

1. A system for mounting a motor control unit at a position on a boat comprising:
a mounting bracket mountable to the position on the boat;
a sliding bracket attachable to the motor control unit and operable to slide into the mounting bracket; and
a quick-release mechanism operable to secure the sliding bracket to the mounting bracket.

2. The mounting bracket of claim 1 further comprising:
rails operable to receive the sliding bracket.

3. The sliding bracket of claim 2 further comprising:
grooves operable to slide into the mounting bracket via the rails.

4. The system of claim 1, wherein:
the quick-release mechanism secures the sliding bracket to the mounting bracket via insertion through the mounting bracket and the sliding bracket.

5. A system for mounting a motor control unit at multiple positions on a boat comprising:
a first mounting bracket operable to mount the motor control unit at a first position on the boat;
a second mounting bracket operable to mount the motor control unit at a second position on the boat;
a sliding bracket attachable to the motor control unit and operable to slide into the first mounting bracket and the second mounting bracket; and
a quick-release mechanism operable to secure the sliding bracket to the first mounting bracket to secure the motor control unit to the first mounting bracket and also operable to secure the mounting bracket to the second mounting bracket to secure the motor control unit to the second mounting bracket.

6. The system of claim 5 wherein:
the quick-release mechanism is further operable to enable the motor control unit to be released from the first mounting bracket by being detached from the first mounting bracket and the sliding bracket, and is further operable to enable the motor control unit to be released from the second mounting bracket by being detached from the second mounting bracket and the sliding bracket.

7. The system of claim 5 wherein:
the first position is inside of a cabin on the boat; and
the second position is outside of the cabin on the boat.

8. A method for moving a motor control unit from a first station on a boat to a second station on the boat comprising:
removing a quick-release mechanism that secures the motor control unit to a first mounting bracket operable to mount the motor control unit at the first station; and
attaching the quick-release mechanism to the second mounting bracket to secure the motor control unit to the second mounting bracket.

9. The method of claim 8 further comprising:
sliding a sliding bracket off of the first mounting bracket; and
sliding the sliding bracket on to the second mounting bracket.

10. The method of claim 9 wherein the attaching further comprises:
inserting the quick-release mechanism through the second mounting bracket and the sliding bracket.
